(19) United States
(12) Patent Application Publication
(10) Pub. No.: US 2020/0219165 A1
(43) Pub. Date: Jul. 9, 2020

(54) MARKETING SYSTEM AND MARKETING METHOD

(71) Applicant: HON HAI PRECISION INDUSTRY CO., LTD., New Taipei (TW)

(72) Inventor: JUNG-YI LIN, New Taipei (TW)

(21) Appl. No.: 16/690,869

(22) Filed: Nov. 21, 2019

(30) Foreign Application Priority Data
Jan. 8, 2019 (CN) 201910018893.5

(51) Int. Cl. G06Q 30/06; G06Q 30/02; G06K 9/00

(52) U.S. Cl. CPC G06Q 30/0631; G06Q 30/0641; G06K 9/00288; G06Q 30/0255; G06Q 30/0201

(57) ABSTRACT

A marketing system includes at least one camera device detecting an image of a customer entering a designated area in real time, a computing device extracting appearance features of the customer from the image and matching the customer with associated commodities according to a database of appearance features and associated commodities, and at least one mobile terminal. The computing device, the at least one camera device, and the at least one mobile terminal are communicatively coupled through a network. The computing device obtains a navigation map of the designated area, determines location information of the customer entering the designated area, sends the location information to the mobile terminal, and labels the location information in the navigation map in the mobile terminal. The location information of the customer is displayed in a preset symbol in the navigation map according to a location of the associated commodity.

### FIELD

The subject matter herein generally relates to marketing systems, and more particularly to a marketing system implementing a marketing method.

### BACKGROUND

Generally, department stores carry a variety of different commodities. Different kinds of commodities may be bought by different kinds of people.

### BRIEF DESCRIPTION OF THE DRAWINGS

Implementations of the present disclosure will now be described, by way of embodiments, with reference to the attached figures.

FIG. 1 is a diagram of an embodiment of a marketing system.

FIG. 2 is a flowchart of an embodiment of a marketing method.

FIG. 3 is a flowchart of an embodiment of a method of creating a database of appearance features and associated commodities.

FIG. 4 is a block diagram of an embodiment of a marketing device.

FIG. 5 is a block diagram of an embodiment of a computing device implementing a computer program.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

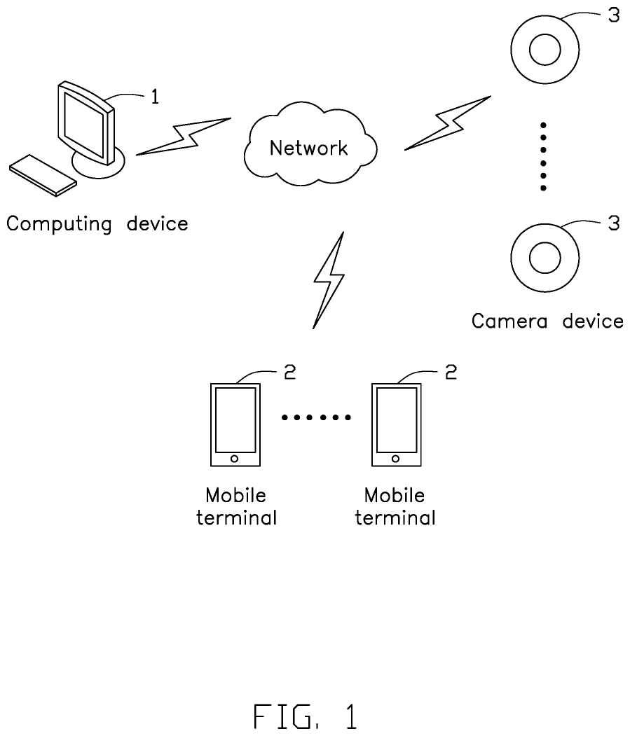

FIG. 1 shows an embodiment of a marketing system. The marketing system includes a computing device 1, at least one mobile terminal 2, and at least one camera device 3 mutually communicatively coupled through a network. The network may be a wired network or a wireless network, such as radio, Wireless Fidelity (WIFI), a cellular network, a satellite network, a broadcast network, or the like.

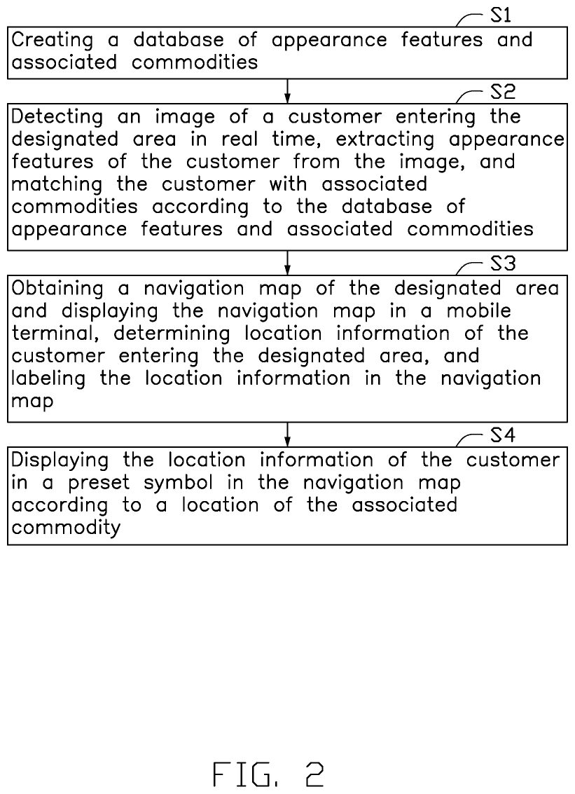

FIG. 2 shows a flowchart of a marketing method. The method is provided by way of embodiment, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure.

At block S1, a database of appearance features and associated commodities is created.

In one embodiment, the appearance features include eyes, eyebrows, nose, mouth, ears, hair, and clothing brand of a customer. The database of appearance features and associated commodities is a collection of commodities bought by customers having one or more of the appearance features. The commodities in the database are commodities associated individually or as an associated purchase with a set of appearance features.

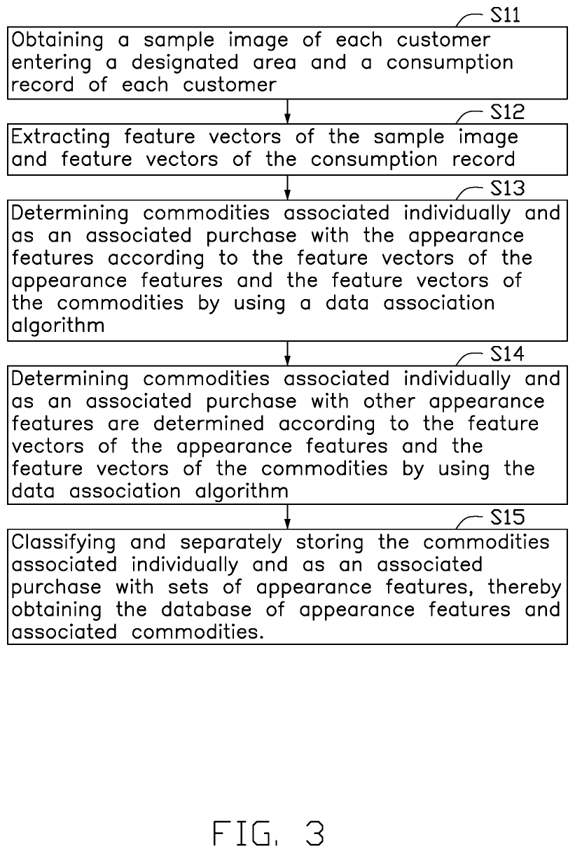

FIG. 3 shows a flowchart of a method for creating the database in block S1. The sequence of blocks in the flowchart may be changed, and some blocks may be omitted.

At block S11, a sample image of each customer entering a designated area and a consumption record of each customer are obtained.

In one embodiment, the sample image of each customer is obtained from the camera device 3 located in the designated area, and the designated area is a checkout counter. The consumption record of each customer is obtained from a charging system of a cash register. The sample image of the customer is stored corresponding to the consumption record of the customer as shown in Table 1 below, wherein A, B, and C represent different types of commodities.

TABLE 1

| Transaction ID | Sample image | Consumption record |
|---|---|---|
| 1000 | Sample image 1 | A, B, C |
| 2000 | Sample image 2 | A, B |
| 3000 | Sample image 3 | C |

In another embodiment, the sample image of the customer is obtained by obtaining image information of the customer entering a designated area from the camera device 3 located at an entrance of the designated area, obtaining membership information of the customer when the customer scans a QR code within the designated area to become a member of the designated area, and storing the image information corresponding to the membership information. The consumption record is obtained from a membership QR code of the customer when the customer purchases a commodity.

At block S12, feature vectors of appearance features in the sample image of the customer and feature vectors of commodities in the consumption record of the customer are extracted.

An AI facial image extraction method is used to disassemble the sample image to obtain the appearance features of the customer, and the appearance features are compared to existing appearance features in the database. The appearance features are classified according to a comparison result. The feature vectors are obtained according to the appearance features assigned to a same class.

The sample image is disassembled to obtain the appearance features of the customer including eyes, eyebrows, nose, mouth, ears, hair, and clothing brand.

The existing appearance features in the database include a facial organ map classified according to different races, genders, skin colors, and ages, and further include picture information of an existing clothing brand. The facial organs in the database are separately stored in the form of pictures. The facial organ maps are marked with information according to race, gender, skin color, and age.

The sample image of the customer is compared to an existing image in the database using the AI facial image comparison method. If the sample image matches the existing image in the database, a name of the existing image is assigned to the sample image.

For example, using the AI image extraction method, the sample image of the customer obtained in block S11 is extracted to obtain image information of the customer's eyes, eyebrows, nose, ears, mouth, and clothing brand. The image information is separately stored in the form of a picture. The image is compared with the existing image in the database by an image template or a histogram. If the image matches the existing image in the database, the name of the existing image is assigned to the image. For example, an image of the eye that matches the existing image in the database according to a histogram may be assigned the name “slanted eyes, Asian, female, yellow skin, 20 years old”.

The same appearance features such as the same gender and the same eyes are classified according to different ages. For example, {female, slanted eyes, 10≤age≤20}=1, {female, slanted eyes, 20≤age≤30}=2, {female, slanted eyes, 30≤age≤40}=3, and so on. Then, the consumption records of customers with the above appearance features are extracted. For example, consumption records of four customers classified as {female, slanted eyes, 10≤age≤20} are retrieved, and the purchased commodities are represented by letters A, B, C, D, and E, as shown in Table 2 below.

TABLE 2

| {Female, slanted eyes, 10 ≤ age ≤ 20} | Consumption record |
|---|---|
| Customer 1 | A, C, D |
| Customer 2 | B, C, E |
| Customer 3 | A, B, C, E |
| Customer 4 | B, E |

At block S13, commodities associated individually and as an associated purchase with the appearance features are determined according to the feature vectors of the appearance features and the feature vectors of the commodities by using a data association algorithm.

For example, the data in Table 2 is processed using the Apriori algorithm. First, a number of purchases of each commodity is counted, such as {A}=2, {B}=3, {C}=3, {D}=1, and {E}=3, and then sorted by highest number of purchases. Thus, the customers having the set of appearance features {female, slanted eyes, 10≤age≤20} purchased the commodities B, C, E three times and only purchased the commodity D once. The data {D} may be excluded. In other embodiments, the commodity that has been purchased twice or other number of times may be excluded according to a threshold number set according to actual needs. Then, a number of purchases of a pair of commodities is counted, such as {A, B}=1, {A, C}=2, {A, E}=1, {B, C}=2, {B, E}=3, and {C, E}=2, and then sorted by highest number of purchases. Thus, the customers having the set of appearance features {female, slanted eyes, 10≤age≤20} purchased the commodities {B, E} three times, purchased the commodities {A, C} and {B, C} two times, and purchased the commodities {A, B} and {A, E} only one time. The data {A, B} and {A, E} may be excluded. A number of purchases of three commodities may also be counted and sorted by highest number of purchases, such as {B, C, E}=2. Thus, the customer who purchased commodities B and C also purchased commodity E.

At block S14, commodities associated individually and as an associated purchase with other appearance features are determined according to the feature vectors of the appearance features and the feature vectors of the commodities by using the data association algorithm.

For example, the Apriori algorithm is used to associate the commodities with a set of appearance features {female, slanted eyes, 20≤age≤30}, {female, slanted eyes, 30≤age≤40}, and so on.

At block S15, the commodities associated individually and as an associated purchase with sets of appearance features are classified and separately stored, thereby obtaining the database of appearance features and associated commodities. Thus, the purchasing habits of the customers having the different sets of appearance features can be known. For example, the customers who have the set of appearance features {female, slanted eyes, 10≤age≤20} purchase the individual commodities B, C, and E the most, purchase the commodity E the most when purchasing the commodity B, and purchase the commodity C the most when purchasing the commodities B and E.

In one embodiment, blocks S11-S15 for creating the database of appearance features and associated commodities may be implemented in an offline state.

At block S2, an image of a customer entering the designated area is detected in real time, appearance features of the customer are extracted from the image, and the customer is matched with the associated commodities according to the database of appearance features and associated commodities.

For example, the image of the customer entering the designated area is acquired by the camera device 3, and the extracted set of appearance features of the customer is {female, slanted eyes, 10≤age≤20}. The information in the database of the appearance features and related products is taken as the product with the characteristic appearance {female, Slanted eyes, 10≤age≤20}. Thus, it is determined that the customer having the set of appearance features {female, slanted eyes, 10≤age≤20} is most likely to purchase the individual commodities B, C, and E the most, purchase the commodity E the most when purchasing the commodity B, and purchase the commodity C the most when purchasing the commodities B and E.

At block S3, a navigation map of the designated area is obtained and displayed in the mobile terminal 2, location information of the customer entering the designated area is determined and sent to the mobile terminal 2, and the location information is labeled in the navigation map in the mobile terminal 2.

Specifically, the designated area is divided into different areas according to different types of commodities, and the navigation map of the designated area is acquired by a plurality of camera devices 3 set in the different areas. In one embodiment, a monitoring range of each camera device 3 is the designated area.

In one embodiment, the camera device 3 set at an entrance of the designated area detects the image of the customer entering the designated area and uses AI facial recognition to extract the appearance features of the customer.

When the customer enters the designated area, the camera devices 3 of the different areas acquire the image of the customer and use AI facial recognition to extract the appearance features of the customer as the customer enters different areas of the designated area. The appearance features are compared to the appearance features acquired by the camera device 3 set at the entrance of the designated area, and the location information of the customer having the same appearance features is transmitted to the mobile terminal 2 and displayed in the navigation map of the mobile terminal 2. The location information corresponds to a location of the camera device 3 that acquires the appearance features of the customer.

At block S4, the location information of the customer is displayed in a preset symbol in the navigation map according to a location of the associated commodity.

For example, when the customer described in block S2 enters the designated area of the commodities B, C, and E, the location information of the customer is displayed in the navigation map with a special color, such as red to indicate that the commodities are strongly associated with the customer, or orange to indicate that the commodities are moderately associated with the customer. In one embodiment, the strongly associated commodity is a commodity individually associated with the appearance features, and the moderately associated commodity is a commodity associated as an associated purchase with the appearance features.

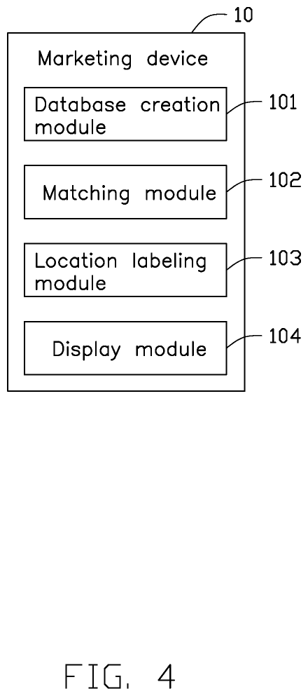

FIG. 4 shows a block diagram of an embodiment of a marketing device 10.

The marketing device 10 is operable in a computing device, such as the computing device 1. The computing device is coupled to a plurality of mobile terminals through a network. The marketing device 10 can include a plurality of functional modules, such as a database creation module 101, a matching module 102, a location labeling module 103, and a display module 104.

The database creation module 101 obtains a sample image of a customer entering a designated area and a consumption record of the customer, extracts feature vectors of appearance features of the sample image of the customer and extracts feature vectors of commodities in the consumption record of the customer, determines commodities associated individually and as an associated purchase with the appearance features according to the feature vectors of the appearance features and the feature vectors of the commodities by using a data association algorithm, determines commodities associated individually and as an associated purchase with other appearance features according to the feature vectors of the appearance features and the feature vectors of the commodities by using the data association algorithm, and classifies and separately stores the commodities associated individually and as an associated purchase with sets of appearance features, thereby obtaining a database of appearance features and associated commodities.

The matching module 102 detects an image of a customer entering the designated area in real time, extracts appearance features of the customer from the image, and matches the customer with the associated commodities according to the database of appearance features and associated commodities.

The location labeling module 103 obtains a navigation map of the designated area, displays the navigation map in the mobile terminal, determines location information of the customer entering the designated area, sends the location information to the mobile terminal, and labels the location information in the navigation map in the mobile terminal.

The display module 104 displays the location information of the customer in a preset symbol in the navigation map according to a location of the associated commodity.

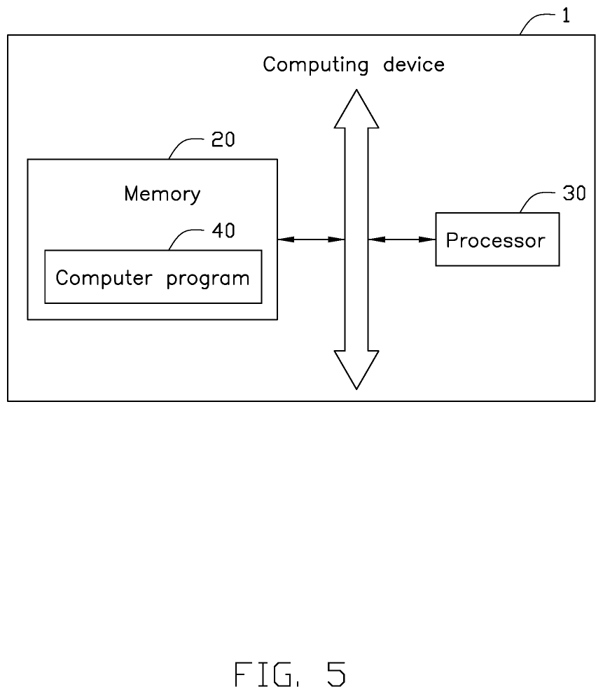

FIG. 5 shows a block diagram of an embodiment of a computing device. The computing device 1 includes a memory 20, a processor 30, and a computer program 40 stored in the memory 20 and executable by the processor 30. In one embodiment, when the processor 30 executes the computer program 40, the blocks of the marketing method shown in FIG. 2 are implemented. In another embodiment, when the processor 30 executes the computer program 40, the functional modules 101-104 of the marketing device 10 shown in FIG are implemented.

The computer program 40 can be partitioned into one or more modules/units that are stored in the memory 20 and executed by the processor 30. The one or more modules/units may be a series of computer program instructions capable of performing particular functions of the computer program 40. For example, the computer program 40 can be divided into the database creation module 101, the matching module 102, the location labeling module 103, and the display module 104.

The computing device 1 may be a desktop computer, a notebook computer, a cloud server, or the like. The computing device 1 may include more or less components than those illustrated, and some components may be combined. The computing device 1 may also include input and output devices, network access devices, buses, and the like.

The processor 30 may be a central processing unit (CPU), or may be other general-purpose processors, a digital signal processor (DSP), an application specific integrated circuit (ASIC), a Field-Programmable Gate Array (FPGA), or other programmable logic device, discrete gate or transistor logic device, discrete hardware components, or the like. The processor 30 may be a microprocessor or other processor known in the art.

The memory 20 can be used to store the computer program 40 and/or modules/units by running or executing computer programs and/or modules/units stored in the memory 20. The memory 20 may include a storage program area and a storage data area. In addition, the memory 20 may include a high-speed random access memory, a non-volatile memory such as a hard disk, a plug-in hard disk, a smart memory card (SMC), and a secure digital (SD) card, flash card, at least one disk storage device, flash device, or other volatile solid state storage device.

The mobile terminal 2 may be an electronic device such as a smart phone, a tablet computer, a laptop computer, a desktop computer, a pair of augmented reality glasses, or the like having a display screen.

The camera device 3 may be an electronic device such as a camera, a surveillance device, or the like having video and still image capturing functions.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A marketing method comprising:
detecting an image of a customer entering a designated area in real time, extracting appearance features of the customer from the image, and matching the customer with associated commodities according to a database of appearance features and associated commodities;
obtaining a navigation map of the designated area, displaying the navigation map in a mobile terminal, determining location information of the customer entering the designated area, sending the location information to the mobile terminal, and labeling the location information in the navigation map in the mobile terminal; and
displaying the location information of the customer in a preset symbol in the navigation map according to a location of the associated commodity.

2. The marketing method of claim 1, wherein the database of appearance features and associated commodities is created by:
obtaining a sample image of each customer entering the designated area and a consumption record of each customer;
extracting feature vectors of the appearance features of the sample image of the customer and feature vectors of the commodities of the consumption record of the customer;
determining commodities associated individually and as an associated purchase with the appearance features according to the feature vectors of the appearance features and the feature vectors of the commodities by using a data association algorithm; and
classifying and separately storing the commodities associated individually and as an associated purchase with the set of appearance features to obtain the database of appearance features and associated commodities.

3. The marketing method of claim 2, wherein:
the sample images of the customers are obtained from a camera device located in the designated area.

4. The marketing method of claim 2, wherein:
the consumption record of the customers are obtained from a charging system of a cash register;
the sample images of the customers are stored corresponding to the consumption record of the customer.

5. The marketing method of claim 2, wherein the sample image of each customer is obtained by:
obtaining image information of the customer entering the designated area from a camera device located at an entrance of the designated area;
obtaining membership information of the customer when the customer scans a QR code within the designated area to become a member of the designated area; and
storing the image information corresponding to the membership information; wherein the consumption record is obtained from a membership QR code of the customer when the customer purchases a commodity.

6. The marketing method of claim 2, wherein:
an AI facial image extraction method is used to disassemble the sample image to obtain the appearance features of the customer;
the appearance features are compared to existing appearance features in the database;
the appearance features are classified according to a comparison result;
the feature vectors of the appearance features are obtained according to the appearance features assigned to a same class;
the commodities in the consumption record are sorted according to commodity name and a consumption level, and different consumption levels of a same type of commodity are assigned to obtain feature vectors of the commodities.

7. The marketing method of claim 2, wherein the step of using a data association algorithm on the feature vectors of the sample image and the feature vectors of the consumption record to associate the commodities individually or as an associated purchase with a set of appearance features comprises:
determining, by the data association algorithm, an association degree between different appearance features and different commodities;
comparing the association degree to a threshold number;
storing the association degrees higher than the threshold number, the commodity being an associated commodity of the appearance feature; and
storing the commodities in the database as commodities associated individually or as an associated purchase with a set of appearance features.

8. The marketing method of claim 1, wherein the step of detecting an image of a customer entering a designated area in real time, extracting appearance features of the customer from the image, and matching the customer with associated commodities according to a database of appearance features and associated commodities comprises:
using an AI facial image extraction method to disassemble the image of the customer to obtain appearance features of the customer;
comparing the appearance features to existing appearance features in the database of appearance features and associated commodities; and
determining the commodity associated with the appearance features according to a result of comparison.

9. The marketing method of claim 1, wherein the step of obtaining a navigation map of the designated area, displaying the navigation map in a mobile terminal, determining location information of the customer entering the designated area, sending the location information to the mobile terminal, and labeling the location information in the navigation map in the mobile terminal comprises:
dividing the designated area into different areas according to different types of commodities, and acquiring the navigation map of the designated area by a plurality of camera devices set in the different areas, wherein a monitoring range of each camera device is the designated area;
detecting, by the camera device set at an entrance of the designated area, the image of the customer entering the designated area and using AI facial recognition to extract appearance features of the customer;
acquiring, by the camera devices in the different areas when the customer enters the designated area, the image of the customer and using AI facial recognition to extract the appearance features of the customer as the customer enters different areas of the designated area;
comparing the appearance features to the appearance features acquired by the camera device set at the entrance of the designated area, and transmitting the location information of the customer having the same appearance features to the mobile terminal;
displaying the location information in the navigation map of the mobile terminal, wherein the location information corresponds to a location of the camera device that acquires the appearance features of the customer.

10. A marketing system comprising:
at least one camera device detecting an image of a customer entering a designated area in real time;
a computing device extracting appearance features of the customer from the image, and matching the customer with associated commodities according to a database of appearance features and associated commodities; and
at least one mobile terminal; wherein:
the computing device, the at least one camera device, and the at least one mobile terminal are communicatively coupled through a network;
the computing device obtains a navigation map of the designated area, determines location information of the customer entering the designated area, sends the location information to the mobile terminal, and labels the location information in the navigation map in the mobile terminal;
the location information of the customer is displayed in a preset symbol in the navigation map according to a location of the associated commodity.

11. The marketing system of claim 10, wherein the database of appearance features and associated commodities is created by:
obtaining, by the at least one camera device, a sample image of each customer entering the designated area, and obtaining a consumption record of each customer;
extracting, by the computing device, feature vectors of the appearance features of the sample image of the customer and extracting feature vectors of the commodities of the consumption record of the customer;
determining, by the computing device, commodities associated individually and as an associated purchase with the appearance features according to the feature vectors of the appearance features and the feature vectors of the commodities by using a data association algorithm; and
classifying, by the computing device, and separately storing the commodities associated individually and as an associated purchase with the set of appearance features to obtain the database of appearance features and associated commodities.

12. The marketing system of claim 11, wherein:
the consumption record of the customer is obtained from a charging system of a cash register;
the sample image of the customer is stored corresponding to the consumption record of the customer.

13. The marketing system of claim 11, wherein the sample image of the customer is obtained by:
obtaining image information of the customer entering the designated area from a camera device located at an entrance of the designated area;
obtaining membership information of the customer when the customer scans a QR code within the designated area to become a member of the designated area; and
storing the image information corresponding to the membership information; wherein the consumption record is obtained from a membership QR code of the customer when the customer purchases a commodity.

14. The marketing system of claim 11, wherein:
the computing device uses an AI facial image extraction method to disassemble the sample image to obtain the appearance features of the customer;
the computing device compares the appearance features to existing appearance features in the database;
the computing device classifies the appearance features according to a comparison result and obtains the feature vectors of the appearance features according to the appearance features assigned to a same class;
the computing device sorts the commodities in the consumption record according to commodity name and a consumption level, and assigns different consumption levels of a same type of commodity to obtain feature vectors corresponding to different commodities.

15. The marketing system of claim 11, wherein the computing device uses a data association algorithm on the feature vectors of the sample image and the feature vectors of the consumption record to associate the commodities individually or as an associated purchase with a set of appearance features by:
determining, by the data association algorithm, an association degree between different appearance features and different commodities;
comparing the association degree to a threshold number;
storing the association degrees higher than the threshold number, the commodity being an associated commodity of the appearance feature; and
storing the commodities in the database as commodities associated individually or as an associated purchase with a set of appearance features.

16. The marketing system of claim 10, wherein:
the computing device uses an AI facial image extraction method to disassemble the image of the customer to obtain appearance features of the customer;
the computing device compares the appearance features to existing appearance features in the database of appearance features and associated commodities; and
the computing device determines the commodity associated with the appearance features according to a result of comparison.

17. The marketing system of claim 10, wherein:
the computing device divides the designated area into different areas according to different types of commodities, and acquiring the navigation map of the designated area by a plurality of the camera devices set in the different areas, wherein a monitoring range of each of the plurality of camera devices is the designated area;
the camera device set at an entrance of the designated area detects the image of the customer entering the designated area, and the computing device uses AI facial recognition to extract appearance features of the customer;
the camera devices set in the different areas acquires the image of the customer when the customer enters the designated area, and the computing device uses AI facial recognition to extract the appearance features of the customer as the customer enters different areas of the designated area;
the computing device compares the appearance features acquired by the camera devices set in the different area to the appearance features acquired by the camera device set at the entrance of the designated area, and transmits the location information of the customer having the same appearance features to the mobile terminal;
the computing device displays the location information in the navigation map of the mobile terminal, wherein the location information corresponds to a location of the camera device that acquires the appearance features of the customer.
